(19) United States
(12) Patent Application Publication
(10) Pub. No.: US 2024/0289923 A1
(43) Pub. Date: Aug. 29, 2024

(54) METHOD FOR DISPLAYING INFORMATION, ELECTRONIC DEVICE, AND STORAGE MEDIUM

(71) Applicant: BEIJING DAJIA INTERNET INFORMATION TECHNOLOGY CO., LTD., Beijing (CN)

(72) Inventors: Yuan WANG, Beijing (CN); Wusheng LI, Beijing (CN); Jing LI, Beijing (CN)

(21) Appl. No.: 18/243,144

(22) Filed: Sep. 7, 2023

(30) Foreign Application Priority Data
Feb. 23, 2023 (CN) 202310189356.3

(51) Int. Cl. G06T 5/50; G06F 3/0482; G06F 3/04845

(52) U.S. Cl. CPC G06T 5/50; G06F 3/0482; G06F 3/04845; G06T 2207/20221

(57) ABSTRACT

The disclosure relates to a method for displaying information, an electronic device and a storage medium. The method includes: displaying a first display interface including a target object, and forming a combined interface based on the target object and an associated object of the target object; and displaying a target interface including a combined image and a resource interaction option in response to a trigger operation for the combined interface, in which the combined image is an image of a combined object obtained by combining the target object with at least one associated object of the target object, and the resource interaction option is used to perform a resource interaction operation on an object included in the combined image.

### CROSS REFERENCE TO RELATED APPLICATIONS

This application is based on and claims priority to Chinese Patent Application No. 202310189356.3, filed on Feb. 23, 2023, in the China National Intellectual Property Administration, the disclosure of which is herein incorporated by reference in their entireties.

### TECHNICAL FIELD

The present disclosure relates to a field of computer technologies, and particularly to a method and an apparatus for displaying information, an electronic device and a storage medium.

### BACKGROUND

With rapid development of mobile Internet technologies, various information may be quickly propagated based on the mobile Internet technologies. Specifically, there is a virtual space technology that a content producer in a virtual space may interact information with a plurality of content consumers in the virtual space. Therefore, more and more content consumers may consume within the virtual space.

In the related art, information of an object displayed in the virtual space is generally only related to the object itself, and information display is relatively single, resulting in a low interaction willingness of resource data of a user in the virtual space.

### SUMMARY

The present disclosure provides a method for displaying information, an electronic device and a storage medium.

According to a first aspect of embodiments of the present disclosure, a method for displaying information is provided, and the method includes:
displaying a first display interface including a target object, and forming a combined interface based on the target object and an associated object of the target object; and
displaying a target interface including a combined image and a resource interaction option in response to a trigger operation for the combined interface, in which the combined image is an image of a combined object obtained by combining the target object with at least one associated object of the target object, and the resource interaction option is used to perform a resource interaction operation on an object included in the combined image.

According to a second aspect of embodiments of the present disclosure, an electronic device is provided, and the electronic device includes:
a processor; and
a memory for storing instructions executable by the processor;
in which the processor is configured to execute the instructions to implement the method for displaying information as described in any one of the first aspect.

According to a third aspect of embodiments of the present disclosure, a non-transitory computer-readable storage medium is provided, in which when instructions in the computer-readable storage medium are executed by a processor of an electronic device, the electronic device is caused to perform the method for displaying information as described in any one of the first aspect of embodiments of the present disclosure.

It should be noted that, the details above and in the following are exemplary and illustrative, and do not constitute the limitation on the present disclosure.

### BRIEF DESCRIPTION OF THE DRAWINGS

The drawings herein are incorporated into the specification and constitute a part of the specification, show embodiments in conformity with embodiments of the present disclosure, and explain the principle of the present disclosure together with the specification, and do not constitute an incorrect limitation of the present disclosure.

FIG. 1 is a flowchart illustrating a method for displaying information according to an embodiment.

FIG. 2 is a flowchart illustrating a method for displaying information according to an embodiment.

FIG. 3 is a flowchart illustrating a method for displaying information according to an embodiment.

FIG. 4 is a flowchart illustrating a method for displaying information according to an embodiment.

FIG. 5 is a flowchart illustrating a method for displaying information according to an embodiment.

FIG. 6a is a schematic diagram illustrating an object display interface in a method for displaying information according to an embodiment.

FIG. 6b is a schematic diagram illustrating an object display interface in a method for displaying information according to an embodiment.

FIG. 6c is a schematic diagram illustrating a target interface in a method for displaying information according to an embodiment.

FIG. 6d is a schematic diagram illustrating a target interface in a method for displaying information according to an embodiment.

FIG. 7 is a schematic diagram illustrating an interface in a method for displaying information according to an embodiment.

FIG. 8 is a block diagram illustrating an apparatus for displaying information according to an embodiment.

FIG. 9 is a block diagram illustrating an electronic device according to an embodiment.

### DETAILED DESCRIPTION

In order to make those skilled in the art better understand the technical solution of the present disclosure, the technical solution in embodiments of the present disclosure will be described clearly and completely in combination with the appended drawings in embodiments of the present disclosure.

It needs to be noted that, the “first”, “second” or similar words used in the present summary and the appended claims are configured only to distinguish similar objects, rather than describe a specific order or a precedence order. It should be understood that the data used herein may be interchanged where appropriate so that the embodiments of the present disclosure described herein may be implemented in an order other than illustrated or described herein. The implementations described in the following exemplary embodiments do not represent all implementations consistent with the present disclosure. Rather, they are merely examples of apparatuses and methods consistent with some aspects of the disclosure as detailed in the appended claims.

It should be noted that user information (including but not limited to user equipment information and user personal information) and data (including but not limited to displayed data and analyzed data) involved in the present disclosure are information and data authorized by a user or fully authorized by each party.

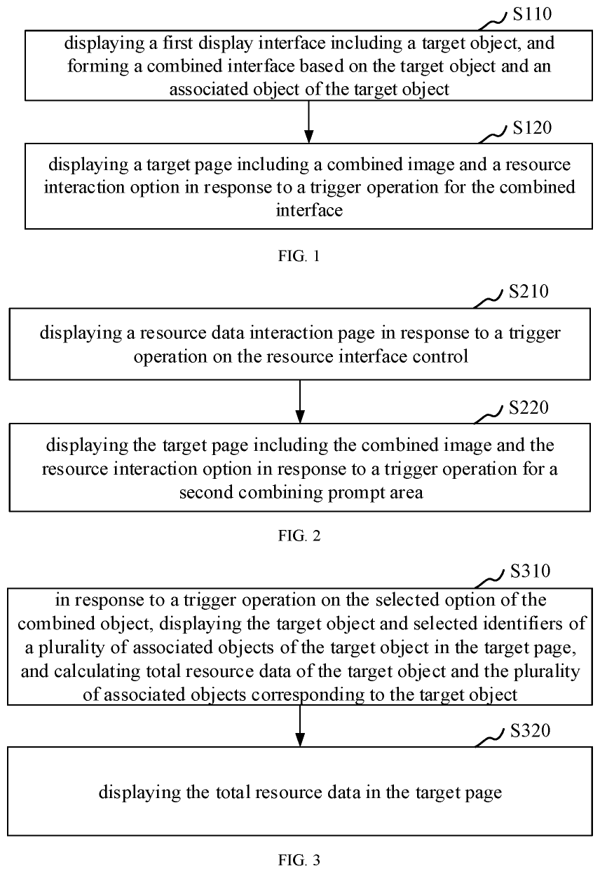

FIG. 1 is a flowchart illustrating a method for displaying information according to an embodiment. As illustrated in FIG. 1, the method for displaying information is applicable to a terminal, and includes the following blocks.

At block S110, a first display interface including a target object is displayed, and a combined interface is formed based on the target object and an associated object of the target object.

The first display interface may be a display interface in a virtual space, or may be a display interface in an information flow, or may be a display interface in video data, etc. The target object may be an object displayed in the virtual space by a content producer in the virtual space at a current moment. The association object of the target object is an object having an association relationship or a corresponding relationship with the target object, for example, may be an object which can be combined with the target object to obtain a combined object. The combined interface may be an interface displayed on the first display interface.

In an example, the virtual space may be a space of a resource interaction type, and the target object may be an object for resource data interaction. For example, the virtual space may be an e-commerce live streaming room, the content producer may be an anchor that establishes the live streaming room, the target object may be a target commodity which is recommended by the anchor, and the associated objects of the target object may be a plurality of associated commodities having a match relationship with the target commodity, etc.

In an implementation, a live streaming client is installed on a terminal, a content consumer may access a virtual space established by the content producer through the live streaming client running on the terminal. After the content consumer enters the virtual space, the terminal may display the first display page including the target object. Based on this, the terminal may acquire the target object included in the first display interface, determine at least one associated object of the target object, form the combined interface based on the target object and the at least one associated object of the target object, and display the combined interface on the first display interface.

At block S120, a target interface including the combined image and a resource interaction option is displayed in response to a trigger operation for the combined interface.

The combined image is an image of a combined object obtained by combining the target object with the at least one associated object of the target object. The resource interaction option may be an interface element on the target interface and the resource interaction option is used to perform a resource interaction operation on one or more objects included in the combined image.

In the implementation, a user may perform a trigger operation on the combined interface on the first display interface based on a page display requirement in an actual application scenario, so that the terminal may determine the combined image corresponding to the target object and display the target interface including the combined image and the resource interaction option, in response to the trigger operation for the combined interface. On the basis of this, the user may perform a trigger operation on the resource interaction option on the terminal. In response to the trigger operation on the resource interaction option, the terminal may perform a resource data interaction between a user account corresponding to the user and an account corresponding to the target object.

In an example, in response to the trigger operation for the combined interface, the terminal may look up a combined object corresponding to the target object in a preconfigured combined image database, and display the target interface including the combined image. Alternatively, in response to the trigger operation for the combined interface, the terminal may acquire image data of the target object and one or more associated objects after determining the one or more associated objects of the target object, obtain the combined object and the combined image by combining the image data of the target object and the one or more associated objects, and display the target interface including the combined image.

In another example, a plurality of combined images corresponding to the target object may be stored in the preconfigured combined image database for the target object, so that the terminal may determine a combined image displayed on the target interface from the plurality of combined images based on a random strategy, or the terminal may determine the number of interactions of resource data corresponding to each of the plurality of combined images, and determine a combined image with a highest number of interactions of the resource data as the combined image displayed on the target interface.

In the method for displaying information, the first display interface including the target object is displayed, and the combined interface is formed based on the target object and the associated object of the target object; and the target interface including the combined image and the resource interaction option is displayed in response to the trigger operation for the combined interface. The combined image is the image of the combined object obtained by combining the target object with at least one associated object of the target object, and the resource interaction option is used to perform the resource interaction operation on the object included in the combined image. According to the disclosure, comprehensive information about the target object may be displayed for a content consumer in the virtual space, so that an interaction willingness and an interaction experience of the content consumer in the virtual space may be enhanced.

In an embodiment, the combined interface includes a thumbnail image of the target object and a first combining prompt area.

Specifically, the combined interface is an interface displayed on a first display interface, the first display interface may be a display interface in a virtual space established by a content producer, and the content producer may generate the first display page by displaying the target object in the virtual space. The thumbnail image of the target object may be a preview thumbnail image of the target object. For example, the terminal determines the thumbnail image of the target object and the first combining prompt area corresponding to the target object based on the target object displayed on the first display interface. The terminal corresponding to the content producer may transmit a live streaming data flow of the first display interface including the combined interface to a terminal corresponding to a content consumer, and the first display page may be displayed on the terminal corresponding to the content consumer.

Displaying the target interface including the combined image and the resource interaction option in response to the trigger operation for the combined interface at block 120 may be implemented by:
displaying the target interface including the combined image and the resource interaction option in response to a trigger operation on the first combining prompt area in the combined interface.

The first combining prompt area includes first combining prompt information and a thumbnail image of the associated object of the target object, and the first combining prompt area is adjacent to the thumbnail image of the target object. The first combining prompt information may be information configured to prompt performing a resource data interaction operation on the target object together with the associated object of the target object, and a specific content of the first combining prompt information may be “matching purchase”. The first combining prompt area may further include thumbnail images of a plurality of associated objects corresponding to the target object. For example, a display page of a virtual space may be a live streaming interface, the target object may be an object of tops type, and the associated object of the target object may be an object of bottoms type, an object of accessories type, etc. The combined image corresponding to the target object may be an image formed by combining the object of the tops type, the object of the bottoms type, and the object of the accessories type.

In the implementation, the terminal may display the combined interface including the thumbnail image of the target object and the first combining prompt area on the first display interface, and the user may perform a trigger operation on the first combining prompt area in the combined interface based on a page display requirement, so that the terminal may display the target interface including the combined image and the resource interaction option in response to the trigger operation on the first combining prompt area in the combined interface.

Based on the above solution, information of the target object may be comprehensively displayed in the virtual space, which enhances an information reach rate.

In an embodiment, the combined interface includes a resource interaction control; specifically, the resource interaction control may be a display control that prompts performing a resource data interaction, for example, may be a display control of a shopping cart type.

As illustrated in FIG. 2, displaying the target interface including the combined image and the resource interaction option in response to the trigger operation for the combined interface at block 120 may be implemented by the following blocks.

At block 210, a resource data interaction page is displayed in response to a trigger operation on the resource interaction control.

The resource data interaction page includes a resource interaction area of the target object, and the resource interaction area includes a second combining prompt area and a thumbnail image of the target object. The resource data interaction page may further include a resource interaction area of one or more other objects.

In an implementation, the resource interaction area of the target object may display the thumbnail image of the target object and the second combining prompt area corresponding to the target object. The thumbnail image of the target object may be preconfigured display image data of the target object, and the second combining prompt area includes second combining prompt information and a thumbnail image of an associated object of the target object. A display size of the thumbnail image of the associated object of the target object is less than a display size of the thumbnail image of the target object. The user may perform a trigger operation on the resource interaction control based on an interaction requirement for resource data, and the terminal may display the resource data interaction page on the first display interface in response to the trigger operation on the resource interaction control.

In an example, the resource interaction area of the target object may further display resource data information of the target object, and the resource data information may include title information, transportation related information, inventory information and a resource value of the target object. For example, when the target object is an object of the tops type, the resource interaction area may display a thumbnail image, title information, transportation related information, inventory quantity information and a resource value of the object of the tops type, and a thumbnail image of an associated object of the object of the tops type, which may, for example, include a thumbnail image of an object of the bottoms type and a thumbnail image of an object of the accessories type.

In another example, the resource data interaction page may be a page displayed in the form of a pop-up window on the first display interface, for example, the resource data interaction page may be an interface displaying specific resource values of a plurality of objects, for example, may be an interface displaying a list of commodity links of a plurality of commodities in a live streaming room.

At block 220, the target interface including the combined image and the resource interaction option is displayed in response to a trigger operation for the second combining prompt area.

The second combining prompt area may be a display area adjacent to the thumbnail image of the target object, for example, the second combining prompt area may be located below the thumbnail image of the target object. The second combining prompt area includes second combining prompt information and one or more thumbnail images of one or more associated objects of the target object. The second combining prompt information may include combining guide information and corresponding discount information. The combining guide information may be information configured to prompt that a user account may perform a resource data interaction operation on the target object together with its associated object. For example, the combining guide information may be “matching purchase”, and the discount information may be “discount up to XX”.

In an implementation, the user may perform a trigger operation on the second combining prompt area corresponding to the target object included in the displayed resource data interaction page based on an interface display requirement, so that the terminal may display the target interface including the combined image and the resource interaction option in response to the trigger operation on any position of the second combining prompt area.

In an example, a resource interaction area of a plurality of other objects may be displayed in the resource data interaction page, and the other object may be an object not having an association relationship with the target object, that is, the other object may be an object that has been displayed by the content producer in the virtual space or may be an object that has not been displayed by the content producer in the virtual space. The resource interaction area of the other object may be the same as the resource interaction area of the target object, which will not be repeated here. In a possible case, the resource interaction area of the other object may display a thumbnail image only having resource data information of the other object, to ensure uniqueness of display of the second combining prompt area in the resource interaction area of the target object.

Based on the above solution, diversity of the display mode of the target interface may be increased, and convenience of an interaction operation of resource data performed by a user account may be improved.

In an embodiment, the target interface further includes a selected option of the combined object. For example, the selected option may be an all selected option.

As illustrated in FIG. 3, the method for displaying information further includes the following blocks.

At block 301, in response to a trigger operation on the selected option of the combined object, the target object and selected identifiers of a plurality of associated objects of the target object are displayed on the target interface, and total resource data of the target object and the plurality of associated objects corresponding to the target object is calculated.

In an implementation, the user may perform a trigger operation on the selected option of the combined object based on a selection requirement for the target object and the associated object of the target object, so that the terminal may display the selected identifier of the target object and the selected identifier of each associated object of the target object on the target interface based on the trigger operation on the selected option of the combined object. For example, the terminal may display identifier information of the target object in a display form of text of a selected type. Based on this, the terminal may calculate total resource data based on the resource data of the target object and the resource data of each associated object of the target object, that is, a sum of the resource data of the target object and the resource data of each associated object of the target object is determined as the total resource data.

At block 302, the total resource data is displayed in the target interface.

In an implementation, the terminal may display the total resource data on the target interface after calculating the total resource data.

Based on the above solution, convenience of selecting a plurality of objects is improved, and validity of displaying information is ensured.

In an embodiment, the method for displaying information further includes: displaying title information corresponding to the target object in the target interface.

The title information is configured to represent a style characteristic of the target object. The title information may be determined based on the style characteristic of the target object, for example, may be preconfigured by the content producer corresponding to the target object, or may be determined by the terminal based on the target object.

In an implementation, the terminal may display title information corresponding to the target object at a target position of the target interface, the target position may be a top position of the target interface, and the target interface may be displayed in the form of a pop-up window in the virtual space.

Based on the above solution, an interaction willingness of resource data of the user account in the virtual space may be increased.

In an embodiment, the method for displaying information further includes: displaying an object display area of the target object and an object display area of the at least one associated object of the target object in the target interface.

The object display area of an object includes a thumbnail image of the object, resource data of the object, and title information of the object. The resource data of the object may be a predetermined specific value (a resource value) of the resource data of the object, and the title information of the object may be predetermined detailed description information of the object.

In the implementation, the terminal may display the object display area of the target object and the object display area of a plurality of associated objects of the target object in the target interface. Specifically, the terminal may display a thumbnail image of the target object, resource data of the target object, title information of the target object, together with a thumbnail image, resource data and title information of an associated object of the target object.

Based on the above solution, comprehensiveness and validity of displaying information may be ensured.

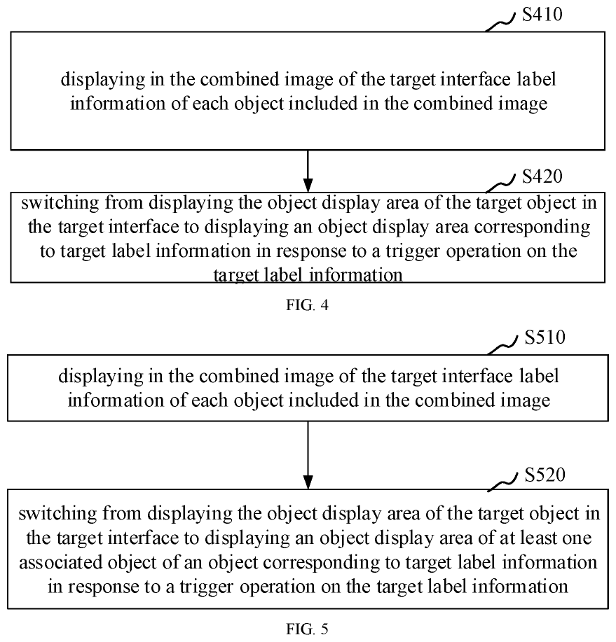

In an embodiment, as illustrated in FIG. 4, the method for displaying information further includes the following blocks.

At block 401, label information of each object included in the combined image is displayed in the combined image of the target interface.

The label information of an object may be brief description information of the object, for example, may be brief description information including a style characteristic. The label information of the object may further be information in a display form of an access link.

In an implementation, the terminal may respectively display in the combined image displayed on the target interface label information of objects included in the combined image.

At block 420, displaying the object display area of the target object in the target interface is switched to displaying an object display area corresponding to target label information in response to a trigger operation on the target label information.

In an implementation, the target label information is any one of label information of a plurality of objects included in the combined image, that is, any one of label information of the plurality of objects included in the combined image selected by the user account based on a selection requirement in an actual scenario. The terminal may switch from displaying the object display area of the target object in the target interface to displaying the object display area of the object corresponding to the target label information in response to a selection trigger operation of the user account on the target label information.

In an example, a display position of the object display area of the target object in the target interface may be immediately below the combined image. In this way, in response to the trigger operation on the target label information, the terminal may display the object display area of the object corresponding to the target label information at the display position immediately below the combined image.

Based on the above solution, diversity of displaying information in the combined image may be enhanced, and a willingness and convenience of resource interaction of the user account are improved.

In an embodiment, as illustrated in FIG. 5, the method for displaying information further includes the following blocks.

At block 501, label information of each object included in the combined image is displayed in the combined image of the target interface.

The label information of the object may be brief description information of the object, for example, may be brief description information including a style characteristic. The label information of the object may further be information in a display form of an access link.

In an implementation, the terminal may respectively display in the combined image displayed on the target interface label information of objects included in the combined image.

At block 520, displaying the object display area of the target object in the target interface is switched to displaying an object display area of at least one associated object of an object corresponding to target label information in response to a trigger operation on the target label information.

In an implementation, the target label information is any one of label information of a plurality of objects included in the combined image, that is, any one of label information of the plurality of objects included in the combined image selected by the user account based on a selection requirement in an actual scenario. In response to a selection trigger operation of the user account on the target label information, the terminal may determine the object corresponding to the target label information (referred to as a selected object for convenience of description) and one or more associated objects corresponding to the selected object, and switch from displaying the object display area of the target object in the target interface to displaying an object display area of the selected object and an object display area of one or more associated objects corresponding to the selected object.

Based on the above solution, a display content of the combined image may be dynamically adjusted based on a trigger operation of the user, which meets the user requirement and improves the user experience.

In an embodiment, the target interface further includes a guide display option, and correspondingly, the method for displaying information further includes: in response to a slide trigger operation on the guide display option, hiding the combined image, and displaying the object display area of the target object and an object display area of a plurality of associated objects corresponding to the target object in the target interface.

In an implementation, the guide display option may be a display option configured to prompt that the user may display more objects, and the guide display option may include guide prompt text information and guide prompt graphic information. For example, the guide prompt text information may be “x style object recommendation”, and the guide prompt graphic information may be double-layer down arrow icon.

Specifically, the user may perform a trigger operation on the guide display option based on the displayed guide display option and a requirement of an actual application scenario, and the terminal may hide an image displaying the combined object in the target interface in response to the trigger operation, and display the object display area of the target object and the object display area of a plurality of associated objects corresponding to the target object in the target interface by means of slide display.

Based on the above solution, convenience of displaying information is ensured.

In an embodiment, calculating the total resource data of the target object and the plurality of associated objects corresponding to the target object may be implemented as follows.

Initial resource data and discount resource data of the target object and the plurality of association objects corresponding to the target object are calculated, and the total resource data is calculated based on the initial resource data and the discount resource data, and the discount resource data and the total resource data are displayed in the target interface.

In an implementation, the terminal may perform calculation based on the initial resource data of the target object and the initial resource data of the plurality of associated objects corresponding to the target object, and determine a sum of the plurality of pieces of initial resource data as initial total resource data. In this way, the terminal may acquire discount condition information, calculate the discount resource data based on the initial total resource data and the discount condition information, determine a difference between the initial total resource data and the discount resource data as the total resource data, and display the total resource data on the target interface.

For example, the discount condition information may be rebate condition information, for example, in response to the resource data being greater than a first threshold, it may be determined that the discount resource data is a second threshold. Specific values of the first threshold and the second threshold are not limited in the disclosure, which may be determined based on the actual application scenario.

In an embodiment, the terminal may display in the combined image of the target interface label information of each object included in the combined image. Text content information of the label information may be determined based on the title information of the object. The terminal may further switch from displaying the target interface to displaying a detailed interface of the object corresponding to the label information based on a trigger operation of the user on the label information, thereby ensuring convenience of user operation and comprehensiveness of displaying information.

The above method for displaying information is described below in combination with a detailed embodiment.

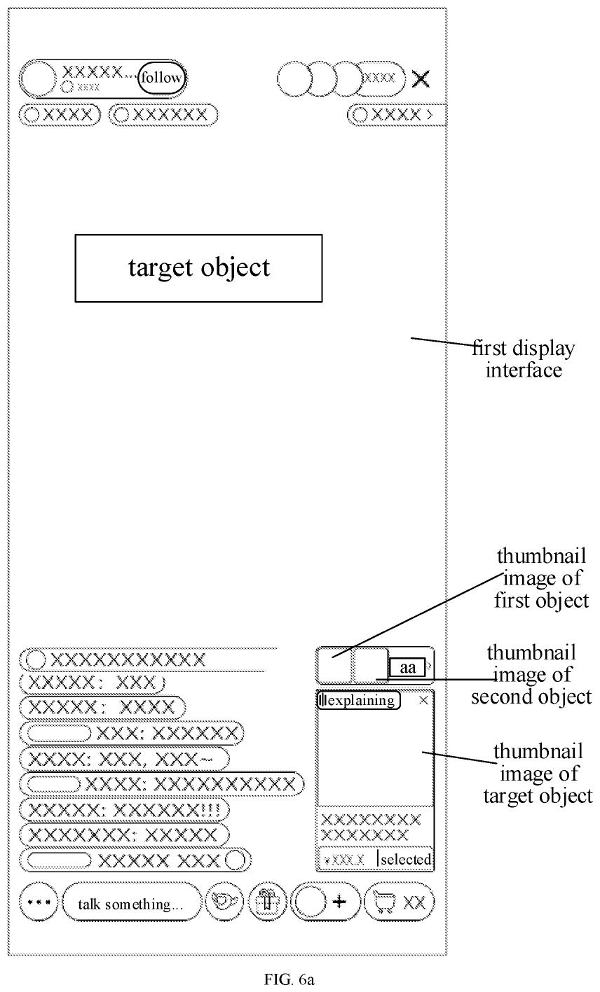

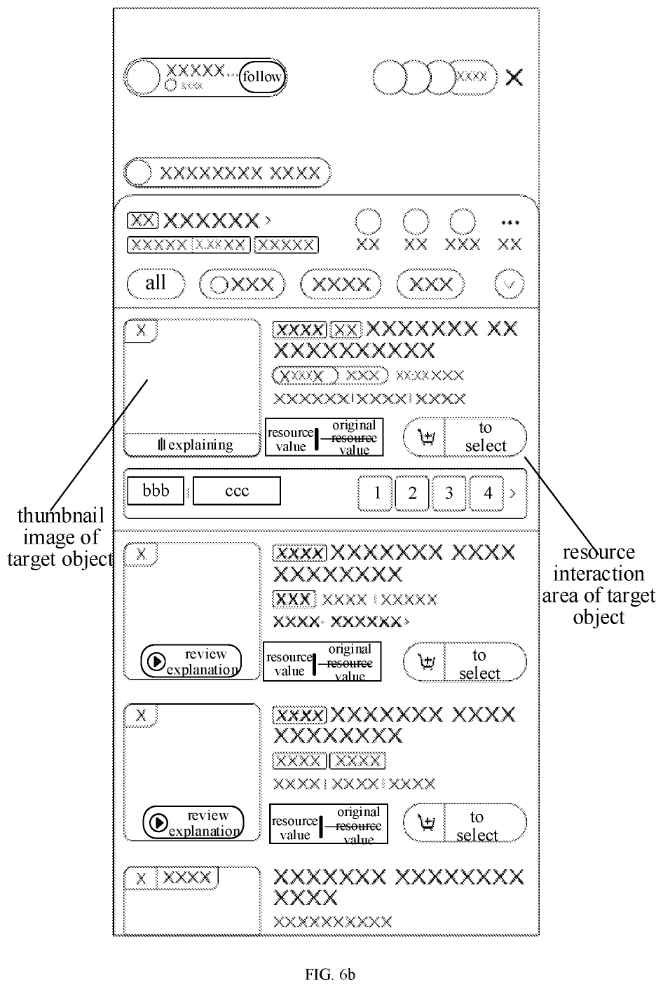

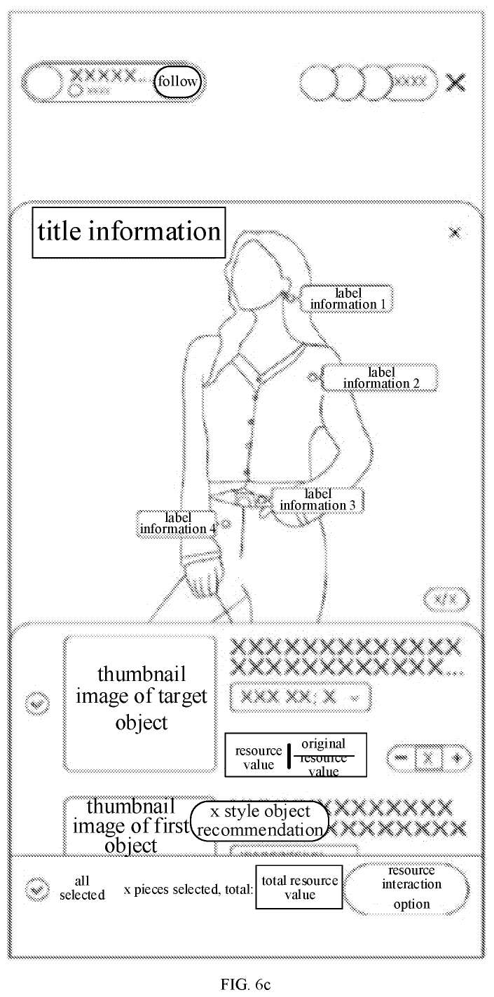

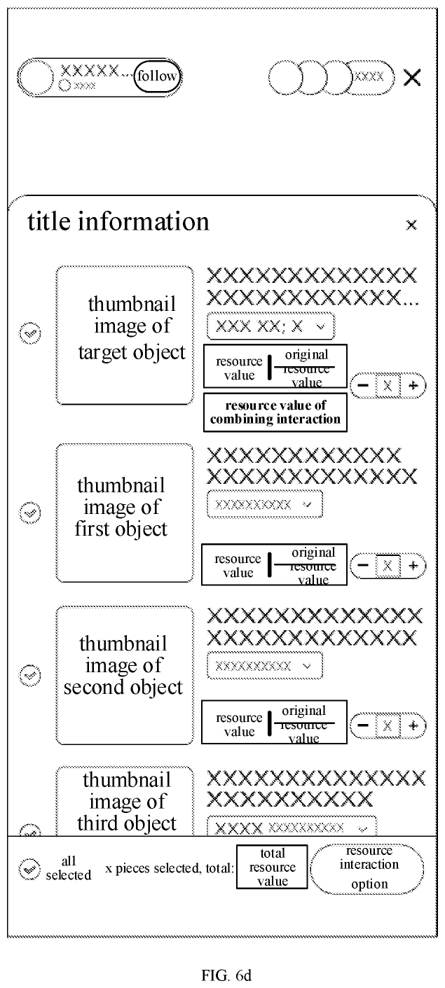

In an example, as illustrated in FIG. 6a, the first display interface may be a display page of a virtual space, and displays a target object and a combined interface. The combined interface displays a thumbnail image of the target object, a thumbnail image of a first object and a thumbnail image of a second object. The first object is an associated object of the target object, and the second object is also an associated object of the target object. Specifically, the combined interface may include the thumbnail image of the target object and a first combining prompt area corresponding to the target object. The first combining prompt area includes first combining prompt information and the thumbnail image of the associated object of the target object, and the first combining prompt area is adjacent to the thumbnail image of the target object. The first combining prompt area may be located above the thumbnail image of the target object, and the first combining prompt information may be “aa”. The combined interface may further display a selected option, and the terminal may display a detailed interface of the target object on the first display interface in response to a trigger operation on the selected option.

In another example, a resource data interaction page displayed on the first display interface may be illustrated in FIG. 6b, the resource data interaction page includes a resource interaction area of the target object, and the resource interaction area includes a second combining prompt area and the thumbnail image of the target object. The resource interaction area may further display an original resource value and a resource value of the object, and display a deletion mark line on the original resource value. The resource data interaction page may further include a resource interaction area of one or more other objects. The second combining prompt area displayed in the resource interaction area may include second combining prompt information and the thumbnail image(s) of one or more associated objects of the target object. The thumbnail images of the plurality of associated targets may include a thumbnail image 1, a thumbnail image 2, a thumbnail image 3 and a thumbnail image 4. The second combining prompt information may include combining guide information “bbb” and corresponding discount information “ccc”. For example, the combining guide information may be “matching purchase”, and the discount information may be “discount up to XX”.

As illustrated in FIG. 6c, the terminal may display a target interface including the combined image and the resource interaction option in the virtual space, the target interface displays the combined image, an object display area of the target object and an object display area of the first object. The combined object in the combined image may be obtained by combining the target object, the first object, the second object and the third object. The combined image may be an image displaying title information, the target object, the first object, the second object and the third object, label information 1, label information 2, label information 3 and label information 4. An object corresponding to the label information 1 is the first object, an object corresponding to the label information 2 is the target object, an object corresponding to the label information 3 is the second object, and an object corresponding to the label information 4 is the third object. The associated objects of the target object include the first object, the second object and the third object. The title information corresponding to the target object is displayed at a target position of the target interface, the target position may be a top position of the target interface, and the target interface may be displayed in the form of a pop-up window in the virtual space.

The object display area of the target object and an object display area of at least one associated object of the target object may be further displayed in the target interface. The object display area of an object may include a thumbnail image of the object, resource data of the object, and title information of the object, and the resource data of the object may include a resource value and an original resource value. A guide display option may be further displayed in the target interface, and the guide display option may include guide prompt text information and guide prompt graphic information. For example, the guide prompt text information may be “x style object recommendation”, and the guide prompt graphic information may be double-layer down arrow icon.

Specifically, the target interface further includes a selected option of the combined object. For example, the selected option may be an all selected option (select all). The target interface may display a total resource value in response to a trigger operation on the all selected option. The target interface displayed on the terminal may further include a resource interaction option, so that the terminal may perform a resource data interaction between a user account corresponding to the terminal and an account corresponding to the target object in response to a trigger operation on the resource interaction option.

As illustrated in FIG. 6d, the terminal may hide an image of the combined object in the target interface in response to a trigger operation on the guide display option, and display the object display area of the target object and the object display area of the plurality of associated objects corresponding to the target object in the target interface by means of slide display. An original resource value, a resource value (a discount resource value) and a resource value of combining interaction may be displayed in the object display area of the target object. The resource value of combining interaction is a resource value of the target object in case that the user account performs a resource data interaction operation on all objects included in the combined image. The target interface may display the object display area of the first object, the object display area of the second object, the object display area of the third object, the total resource value and the resource interaction option, and respectively including the thumbnail image of the first object, the thumbnail image of the second object and the thumbnail image of the third object.

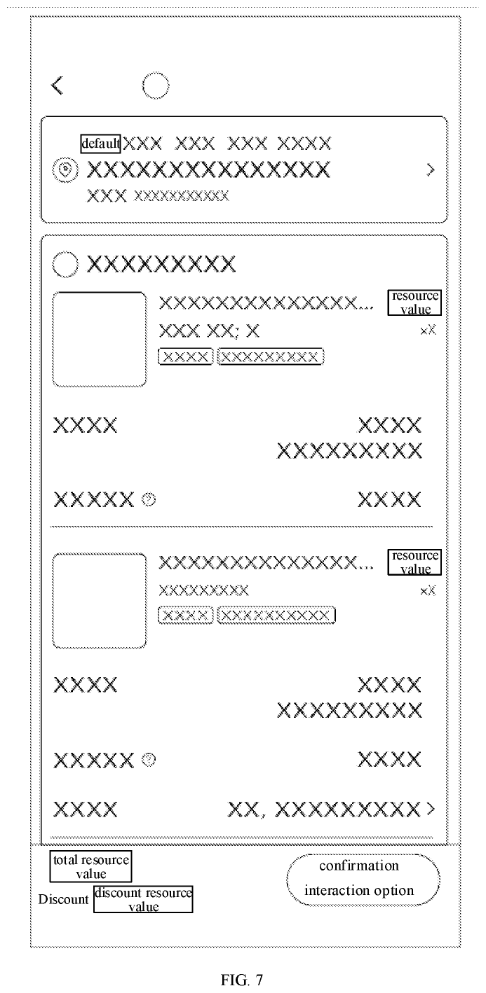

The terminal may switch from displaying FIG. 6c to displaying FIG. 7 in response to a trigger operation of the user on the resource interaction option in FIG. 6d. As illustrated in FIG. 7, the interface includes default shipping address information of the user account corresponding to the terminal, the total resource value, the discount resource value, and a detailed information display area of one or more objects selected by the user account. The detailed information display area of the object includes a thumbnail image, title information and a resource value of the object and a number of objects selected by the user account. A confirmation interaction option is further displayed on the interface. The terminal may perform a resource data interaction between the user account and an account corresponding to the object in response to a trigger operation of the user on the confirmation interaction option.

It should be understood that although steps in flowcharts of FIGS. 1 to 5 are sequentially displayed based on the indication of the arrows, these steps are not necessarily executed in the sequence indicated by the arrows. Unless explicitly stated herein, these steps are not executed in a strict sequence, and may be executed in other sequences. And, at least some of steps in FIGS. 1 to 5 may include a plurality of sub-steps or a plurality of stages, these sub-steps or stages are not necessarily executed at the same moment, but may be executed at different moments, and these steps or stages are not necessarily performed in sequence, but may be performed in turn or alternately with other steps or at least part of sub-steps or stages of other steps.

It may be understood that, same/similar parts of embodiments in the method may be referred to each other. Each embodiment focuses on differences distinguished from other embodiments, and regarding the related contents, reference may be made to descriptions of other method embodiments.

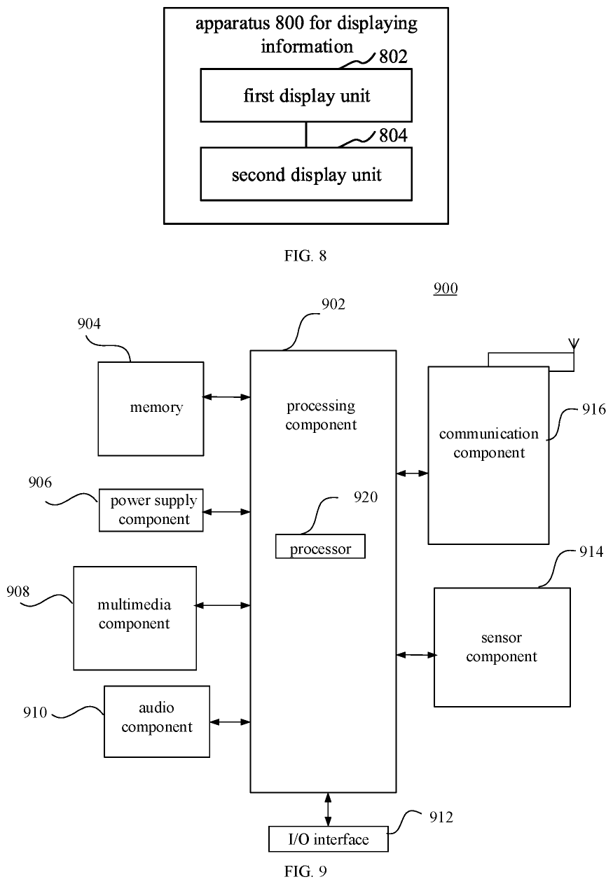

FIG. 8 is a block diagram illustrating an apparatus 800 for displaying information according to an embodiment. As illustrated in FIG. 8, the apparatus includes a first display unit 802 and a second display unit 804.

The first display unit 802 is configured to display a first display interface including a target object, and form a combined interface based on the target object and an associated object of the target object.

The second display unit 804 is configured to display a target interface including a combined image and a resource interaction option in response to a trigger operation for the combined interface, in which the combined image is an image of a combined object obtained by combining the target object with at least one associated object of the target object, and the resource interaction option is used to perform a resource interaction operation on an object included in the combined image.

In an embodiment, the combined interface includes a thumbnail image of the target object and a first combining prompt area.

The second display unit is specifically configured to:
display the target interface including the combined image and the resource interaction option in response to a trigger operation on the first combining prompt area in the combined interface, in which the first combining prompt area includes first combining prompt information and a thumbnail image of the associated object of the target object.

In an embodiment, the combined interface includes a resource interaction control; and the second display unit is specifically configured to:
display a resource data interaction page in response to a trigger operation on the resource interaction control, in which the resource data interaction page includes a resource interaction area of the target object, and the resource interaction area includes a second combining prompt area and a thumbnail image of the target object; and
display the target interface including the combined image and the resource interaction option in response to a trigger operation on the second combining prompt area, in which second combining prompt area includes second combining prompt information and a thumbnail image of the associated object of the target object.

In an embodiment, the target interface further includes a selected option of the combined object, and the apparatus further includes a third display unit and a fourth display unit.

The third display unit is configured to, in response to a trigger operation on the selected option of the combined object, display the target object and selected identifiers of a plurality of associated objects of the target object in the target interface, and calculate total resource data of the target object and the plurality of associated objects corresponding to the target object.

The fourth display unit is configured to display the total resource data in the target interface.

In an embodiment, the apparatus further includes a fifth display unit and a first switch display unit.

The fifth display unit is configured to display in the combined image of target interface label information of each object included in the combined image.

The first switch display unit is configured to switch from displaying an object display area of the target object in the target interface to displaying an object display area corresponding to target label information in response to a trigger operation on the target label information.

In an embodiment, the apparatus further includes a sixth display unit and a second switch display unit.

The sixth display unit is configured to display in the combined image of the target interface label information of each object included in the combined image.

The second switch display unit is configured to switch from displaying an object display area of the target object in the target interface to displaying an object display area of at least one associated object of an object corresponding to target label information in response to a trigger operation on the target label information.

In an embodiment, the apparatus further includes a seventh display unit.

The seventh display unit is configured to display title information corresponding to the target object in the target interface. The title information is configured to represent a style characteristic of the target object.

In an embodiment, the apparatus further includes an eighth display unit.

The eighth display unit is configured to display an object display area of the target object and an object display area of the at least one associated object of the target object in the target interface. The object display area includes a thumbnail image of the object, resource data of the object, and title information of the object.

In an embodiment, the target interface further includes a guide display option, and the apparatus further includes a hiding display unit.

The hiding display unit is configured to, in response to a slide trigger operation on the guide display option, hide the combined image, and display the object display area of the target object and an object display area of a plurality of associated objects corresponding to the target object in the target interface.

With regard to the apparatus in the above embodiments, the specific way in which each module performs the operation has been described in detail in the embodiments of the method and will not be elaborated here.

FIG. 9 is a block diagram illustrating an electronic device 900 for implementing a method for displaying information according to an embodiment. For example, the electronic device 900 may be a mobile phone, a computer, a digital broadcasting terminal, a messaging device, a game console, a tablet device, a medical equipment, a fitness equipment, a personal digital assistant, etc.

As illustrated in FIG. 9, the electronic device 900 may include one or more components: a processing component 902, a memory 904, a power supply component 906, a multimedia component 908, an audio component 910, an input/output (I/O) interface 912, a sensor component 914 and a communication component 916.

The processing component 902 generally controls the whole operation to electronic device 900, such as the operations related to display, phone call, data communication, camera operation and recording operation. The processing component 902 may include one or more processors 920 to perform instructions, to complete all or part of steps of the above method. In addition, the processing component 902 may include one or more modules for the convenience of interaction between the processing component 902 and other components. For example, the processing component 902 may include a multimedia module for the convenience of interaction between the multimedia component 908 and the processing component 902.

The memory 904 is configured to store all types of data to support the operation of the electronic device 900. Examples of the data include the instructions of any applications or methods operated on the electronic device 900, contact data, phone book data, messages, pictures, videos, etc. The memory 904 may be implemented by any type of volatile or non-volatile storage devices or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, an optical disk or a graphene memory.

The power supply component 906 may provide power for all components of the electronic device 900. The power supply component 906 may include a power supply management system, one or more power supplies, and other units related to generating, managing and distributing power for the electronic device 900.

The multimedia component 908 includes an output interface screen provided between the electronic device 900 and the user. In some embodiments, a screen may include a liquid crystal display (LCD) and a touch panel (TP). When the screen includes a touch panel, the screen may be implemented as a touch screen to receive input signals from the user. The touch panel includes one or more touch sensors to sense touch, slide and gestures on the touch panel. The touch sensor may not only sense the boundary of touch or slide action, but also detect the duration and pressure related to the touching or sliding operation. In some embodiments, the multimedia component 908 includes a front camera and/or a rear camera. When the electronic device 900 is in operation mode, such as shooting mode or video mode, the front camera or the rear camera may receive the external multimedia data. Each front camera and rear camera may be a fixed optical lens system or an optical lens system with a focal length and an optical zoom capacity.

The audio component 910 is configured as an output and/or input signal. For example, the audio component 910 includes a microphone (MIC). When the electronic device 900 is in operation mode, such as call mode, record mode, and speech recognition mode, the microphone is configured to receive the external audio signals. The audio signals received may be further stored in the memory 904 or sent via the communication component 916. In some embodiments, the audio component 910 further includes a speaker configured to output an audio signal.

The I/O interface 912 provides an interface for the processing component 902 and the peripheral interface module, and the peripheral interface module may be a keyboard, a click wheel, a button, etc. The buttons may include but not limited to a home button, a volume button, a start button and a lock button.

The sensor component 914 includes one or more sensors, configured to provide various aspects of status assessment for the electronic device 900. For example, the sensor component 914 may detect the on/off state of the electronic device 900 and the relative positioning of the component. For example, the component is a display and a keypad of the electronic device 900. The sensor component 914 may further detect the location change of the electronic device 900 or one component of the electronic device 900, the presence or absence of contact between the user and the electronic device 900, the orientation or acceleration/deceleration of the electronic device 900, and the temperature change of the electronic device 900. The sensor component 914 may include a proximity sensor, which is configured to detect the existence of the objects nearby without any physical contact. The sensor component 914 may further include a light sensor such as CMOS or CCD image sensor, which is configured to use in imaging applications. In some embodiments, the sensor component 914 may further include an acceleration transducer, a gyroscope sensor, a magnetic sensor, a pressure sensor or a temperature sensor.

The communication component 916 is configured for the convenience of wire or wireless communication between the electronic device 900 and other devices. The electronic device 900 may access wireless networks based on communication standards, such as WiFi, an operator network (for example, 2G, 3G, 4G or 5G) or their combination. In an embodiment, the communication component 916 receives broadcast signals or broadcast-related information from an external broadcast management system via a broadcast channel. In an embodiment, the communication component 916 further includes a near field communication (NFC) module to facilitate short-range communication. For example, an NFC module may be implemented based on radio frequency identification (RFID) technology, infrared data association (IRDA) technology, ultra-wideband (UWB) technology, bluetooth (BT) technology and other technologies.

In an embodiment, the electronic device 900 may be implemented by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronics components, which is configured to perform the above method.

In an embodiment, a computer-readable storage medium is further provided which includes instructions, such as the memory 904 including instructions, in which the instructions may be executed by the processor 920 of the electronic device 900 to complete the above methods. For example, the computer readable storage medium may be a ROM, a random access memory (RAM), a CD-ROM, a magnetic tape, a floppy disk, an optical data storage device, etc.

In an exemplary embodiment, a computer program product including instructions is further provided. The instructions may be executed by the processor 920 of the electronic device 900 to complete the above method.

It needs to be noted that, the apparatus, the electronic device, the computer-readable storage medium and the computer program product may further include other implementations according to descriptions of related method embodiments, and specific implementations may refer to descriptions of related method embodiments, which will not be repeated here.

After considering the specification and practicing the disclosure here, those skilled in the art will easily think of other implementations. The present application is intended to cover any variations, usages, or adaptive changes of the present disclosure. These variations, usages, or adaptive changes follow the general principles of the present disclosure and include common knowledge or conventional technical means in the technical field not disclosed by the present disclosure. The description and the embodiments are to be regarded as exemplary only, and the true scope and spirit of the present disclosure are given by the appended claims.

It should be understood that the present disclosure is not limited to the precise structure described above and shown in the drawings, and various modifications and changes may be made without departing from its scope. The scope of the present application is only limited by the appended claims. The scope of the present application is only limited by the appended claims.

1. A method for displaying information, comprising:
displaying a first display interface comprising a target object;
forming a combined interface based on the target object and an associated object of the target object; and
displaying a target interface comprising a combined image and a resource interaction option in response to a trigger operation for the combined interface, wherein the combined image is an image of a combined object obtained by combining the target object with at least one associated object of the target object, and the resource interaction option is used to perform a resource interaction operation on an object comprised in the combined image.

2. The method according to claim 1, wherein, displaying the target interface comprising the combined image and the resource interaction option in response to the trigger operation for the combined interface comprises:
determining the combined image from a preconfigured combined image database based on the target object in response to the trigger operation for the combined interface; and
displaying the target interface comprising the combined image and the resource interaction option.

3. The method according to claim 2, wherein, determining the combined image from a preconfigured combined image database based on the target object in response to the trigger operation for the combined interface comprises:
determining a plurality of combined images from the preconfigured combined image database based on the target object in response to the trigger operation for the combined interface;
determining a number of interactions of resource data corresponding to each combined image; and
determining the combined image as a combined image corresponding to a maximum number of interactions.

4. The method according to claim 1, wherein the combined interface comprises a thumbnail image of the target object and a first combining prompt area;
displaying the target interface comprising the combined image and the resource interaction option in response to the trigger operation for the combined interface comprises:
displaying the target interface in response to a trigger operation on the first combining prompt area, wherein the first combining prompt area comprises first combining prompt information and a thumbnail image of the associated object of the target object.

5. The method according to claim 1, wherein, the combined interface comprises a resource interaction control; and displaying the target interface comprising the combined image and the resource interaction option in response to the trigger operation for the combined interface comprises:
displaying a resource data interaction page in response to a trigger operation on the resource interaction control, wherein the resource data interaction page comprises a resource interaction area of the target object, and the resource interaction area comprises a second combining prompt area and a thumbnail image of the target object; and
displaying the target interface in response to a trigger operation on the second combining prompt area, wherein the second combining prompt area comprises second combining prompt information and a thumbnail image of the associated object of the target object.

6. The method according to claim 1, wherein the target interface further comprises a selected option of the combined object, and the method further comprises:
in response to a trigger operation on the selected option, displaying the target object and selected identifiers of a plurality of associated objects of the target object in the target interface, and determining total resource data of the target object and the plurality of associated objects of the target object; and
displaying the total resource data in the target interface.

7. The method according to claim 6, wherein determining the total resource data of the target object and the plurality of associated objects of the target object comprises:
determining initial resource data of the target object and the plurality of associated objects and discount resource data; and
determining the total resource data based on the initial resource data and the discount resource data.

8. The method according to claim 1, further comprising:
displaying title information of the target object in the target interface, wherein the title information is configured to represent a style characteristic of the target object.

9. The method according to claim 1, further comprising:
displaying an object display area of the target object and an object display area of the at least one associated object of the target object in the target interface, wherein the object display area of the target object comprises a thumbnail image of the target object, resource data of the target object, and title information of the target object, and the object display area of the at least one associated object comprises a thumbnail image of the at least one associated object, resource data of the at least one associated object, and title information of the at least one associated object.

10. The method according to claim 9, further comprising:
displaying, in the combined image of the target interface, label information of each object comprised in the combined image; and
switching from displaying the object display area of the target object in the target interface to displaying an object display area of an object corresponding to target label information in response to a trigger operation on the target label information.

11. The method according to claim 9, further comprising:
displaying, in the combined image of the target interface, label information of each object comprised in the combined image; and
switching from displaying the object display area of the target object in the target interface to displaying an object display area of at least one associated object of an object corresponding to target label information in response to a trigger operation on the target label information.

12. The method according to claim 9, wherein the target interface further comprises a guide display option, and the method further comprises:
in response to a slide trigger operation on the guide display option, hiding the combined image, and displaying the object display area of the target object and an object display area of a plurality of associated objects of the target object in the target interface.

13. An electronic device, comprising:
a processor; and
a memory for storing instructions executable by the processor;
wherein the processor is configured to execute the instructions to implement the following operations:
displaying a first display interface comprising a target object;
forming a combined interface based on the target object and an associated object of the target object; and
displaying a target interface comprising a combined image and a resource interaction option in response to a trigger operation for the combined interface, wherein the combined image is an image of a combined object obtained by combining the target object with at least one associated object of the target object, and the resource interaction option is used to perform a resource interaction operation on an object comprised in the combined image.

14. The electronic device according to claim 13, wherein the combined interface comprises a thumbnail image of the target object and a first combining prompt area;
displaying the target interface comprising the combined image and the resource interaction option in response to the trigger operation for the combined interface comprises:
displaying the target interface in response to a trigger operation on the first combining prompt area, wherein the first combining prompt area comprises first combining prompt information and a thumbnail image of the associated object of the target object.

15. The electronic device according to claim 13, wherein, the combined interface comprises a resource interaction control; and displaying the target interface comprising the combined image and the resource interaction option in response to the trigger operation for the combined interface comprises:
displaying a resource data interaction page in response to a trigger operation on the resource interaction control, wherein the resource data interaction page comprises a resource interaction area of the target object, and the resource interaction area comprises a second combining prompt area and a thumbnail image of the target object; and
displaying the target interface in response to a trigger operation on the second combining prompt area, wherein the second combining prompt area comprises second combining prompt information and a thumbnail image of the associated object of the target object.

16. The electronic device according to claim 13, wherein the target interface further comprises a selected option of the combined object, and the method further comprises:
in response to a trigger operation on the selected option, displaying the target object and selected identifiers of a plurality of associated objects of the target object in the target interface, and determining total resource data of the target object and the plurality of associated objects of the target object; and
displaying the total resource data in the target interface.

17. The electronic device according to claim 13, wherein the processor is further configured to perform the following operation:
displaying an object display area of the target object and an object display area of the at least one associated object of the target object in the target interface, wherein the object display area of the target object comprises a thumbnail image of the target object, resource data of the target object, and title information of the target object, and the object display area of the at least one associated object comprises a thumbnail image of the at least one associated object, resource data of the at least one associated object, and title information of the at least one associated object.

18. The electronic device according to claim 17, wherein the processor is further configured to perform the following operations:
displaying, in the combined image of the target interface, label information of each object comprised in the combined image; and
switching from displaying the object display area of the target object in the target interface to displaying an object display area of an object corresponding to target label information in response to a trigger operation on the target label information.

19. The electronic device according to claim 17, wherein the processor is further configured to perform the following operations:
displaying, in the combined image of the target interface, label information of each object comprised in the combined image; and
switching from displaying the object display area of the target object in the target interface to displaying an object display area of at least one associated object of an object corresponding to target label information in response to a trigger operation on the target label information.

20. A non-transitory computer-readable storage medium, wherein when instructions in the computer-readable storage medium are executed by a processor of an electronic device, the electronic device is caused to perform the following operations:
displaying a first display interface comprising a target object;
forming a combined interface based on the target object and an associated object of the target object; and
displaying a target interface comprising a combined image and a resource interaction option in response to a trigger operation for the combined interface, wherein the combined image is an image of a combined object obtained by combining the target object with at least one associated object of the target object, and the resource interaction option is used to perform a resource interaction operation on an object comprised in the combined image.
